(19) United States
(12) Patent Application Publication
(10) Pub. No.: US 2016/0344033 A1
(43) Pub. Date: Nov. 24, 2016

(54) NEGATIVE ELECTRODE FOR NON-AQUEOUS ELECTROLYTE SECONDARY CELL

(71) Applicant: SANYO ELECTRIC CO., LTD., Daito-shi, Osaka (JP)

(72) Inventors: Shinji Kasamatsu, Tokushima (JP); Na Wang, Osaka (JP); Yoshio Kato, Osaka (JP)

(73) Assignee: Sanyo Electric Co., Ltd., Daito-shi, Osaka (JP)

(21) Appl. No.: 15/108,060

(22) PCT Filed: Dec. 12, 2014
(86) PCT No.: PCT/JP2014/006197

§ 371 Date: Jun. 24, 2016

(30) Foreign Application Priority Data
Dec. 26, 2013 (JP) 2013-268660

(51) Int. Cl. H01M 4/62; H01M 10/0525; H01M 4/38; H01M 4/583; H01M 4/133; H01M 4/134

(52) U.S. Cl. CPC H01M 4/622; H01M 4/133; H01M 4/134; H01M 4/386; H01M 4/583; H01M 10/0525

(57) ABSTRACT

Adhesion between particles in a negative electrode for non-aqueous secondary cells is improved for better cycle characteristics. A negative electrode for non-aqueous secondary cells contains silicon-containing particles and graphite particles as negative electrode active materials. The graphite particles have a first coating layer that contains carboxymethyl cellulose, and the first coating layer has an average thickness of 10 nm or more. The silicon-containing particles have a second coating layer that contains carboxymethyl cellulose, and the second coating layer has an average thickness of 10 nm or more.

### TECHNICAL FIELD

The present invention relates to a negative electrode for non-aqueous electrolyte secondary cells.

### BACKGROUND ART

As an attempt to improve the energy density and output of lithium-ion batteries, investigations have been made into the use of negative electrode active materials such as metallic materials that alloy with lithium, such as silicon, germanium, tin, and zinc, and oxides of these metals as an alternative to carbonaceous materials such as graphite.

Negative electrode active materials made from metallic materials that alloy with lithium and/or oxides of these metals are known to experience a loss of cycle characteristics during charge and discharge because of the expansion and contraction of themselves. PTL 1 below proposes a negative electrode for non-aqueous electrolyte secondary cells that contains a composite of a material composed of elements including Si and O and a carbon material as well as a graphitic carbon material as negative electrode active; materials.

### CITATION LIST

### Patent Literature

PTL 1: Japanese Published Unexamined Patent Application No. 2011-233245

### SUMMARY OF INVENTION

### Technical Problem

The non-aqueous electrolyte secondary cell of PTL 1 needs to be further improved in terms of cycle characteristics, compared to those in which graphite is used as a negative electrode active material.

### Solution to Problem

To solve this problem, a negative electrode according to the present invention for non-aqueous electrolyte secondary cells, which contains silicon-containing particles and graphite particles as a negative electrode active material, is characterized in that the graphite particles have a first coating layer that contains carboxymethyl cellulose and that the first coating layer has an average thickness of 10 nm or more.

### Advantageous Effects of Invention

Non-aqueous electrolyte secondary cells with a negative electrode according to the present invention for non-aqueous electrolyte secondary cells have better cycle characteristics because of improved adhesion between particles.

### BRIEF DESCRIPTION OF DRAWINGS

FIG. 1 is a cross-sectional view of a negative electrode as an example of an embodiment of the present invention.

### DESCRIPTION OF EMBODIMENTS

The following describes an embodiment of the present invention in detail.

The drawing referenced in the description of the embodiment is a schematic, and the relative dimensions and other details of the illustrated components are not necessarily to scale. The following description should be considered when any specific relative dimensions or other details of a component are determined.

A non-aqueous electrolyte secondary cell as an example of an embodiment of the present invention includes a positive electrode that contains a positive electrode active material, a negative electrode that contains a negative electrode active material, a non-aqueous electrolyte that contains a non-aqueous solvent, and a separator. An example of a non-aqueous electrolyte secondary cell has a structure in which an electrode body composed of positive and negative electrodes wound with a separator therebetween and a non-aqueous electrolyte are held together in a sheathing body.

### [Positive Electrode]

The positive electrode is preferably composed of a positive electrode collector and a positive electrode active material layer on the positive electrode collector. The positive electrode collector is, for example, a conductive thin-film body, in particular, a foil of a metal or alloy that is stable in the range of positive electrode potentials, such as aluminum, or a film that has a surface layer of a metal such as aluminum. The positive electrode active material layer preferably contains a conductive material and a binder in addition to the positive electrode active material.

The positive electrode active material contains an oxide that contains lithium and one or more metallic elements M, and the one or more metallic elements M include at least one selected from a group including cobalt and nickel. Preferably, the oxide is a lithium transition metal oxide. The lithium transition metal oxide may contain non-transition metals, such as Mg and Al. Specific examples include lithium transition metal oxides such as lithium cobalt oxide, Ni—Co—Mn, Ni—Mn—Al, and Ni—Co—Al. The positive electrode active material can be one of these, and can also be a mixture of two or more.

### [Negative Electrode]

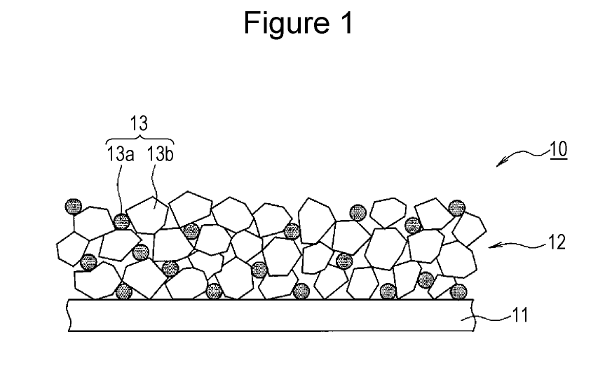

As illustrated in FIG. 1, the negative electrode 10 preferably includes a negative electrode collector 11 and a negative electrode active material layer 12 on the negative electrode collector 11. The negative electrode collector 11 can be, for example, a conductive thin-film body, in particular, a foil of a metal or alloy that is stable in the range of negative electrode potentials, such as copper, or a film that has a surface layer of a metal such as copper.

The negative electrode active material 13 includes a negative electrode active material 13a that is silicon-containing particles and a negative electrode active material 13b that is graphite-containing particles. The negative electrode active material 13a preferably contains SiOₓ, Si, or a Si alloy. Examples of Si alloys include solid solutions of silicon in one or more other elements, intermetallic compounds of silicon and one or more other elements, and eutectic alloys of silicon and one or more other elements. Examples of methods for the production of the alloy include arc melting, liquid quenching, mechanical alloying, sputtering, chemical vapor deposition, and firing. In particular, examples of methods for liquid quenching include single-roller quenching, twin-roller quenching, and atomizing techniques such as gas atomization, water atomization, and disc atomization.

The SiOₓ particles preferably have a conductive coating layer that covers at least part of their surface. The coating layer is a conductive layer made of a material with higher conductivity than SiOₓ. The coating layer is preferably made of an electrochemically stable conductive material, preferably at least one selected from the group consisting of carbon materials, metals, and metallic compounds.

The negative electrode active material 13b is graphite particles with a first coating layer on their surface. The first coating layer contains carboxymethyl cellulose.

The first coating layer has an average thickness of 10 nm or more, more preferably 12 nm or more. An average thickness of the first coating layer of less than 10 nm tends to result in failed collection of current following the expansion or contraction of the negative electrode active; material particles 13a because of insufficient adhesion within the negative electrode active material 13b or between the negative electrode active materials 13a and 13b. The average thickness of the first coating layer is 300 nm or less, more preferably 200 nm or less. An average thickness of the first coating layer greater than 300 nm tends to result in low characteristics due to increased resistance of the coating layer leading to increased resistance of the cell.

The relative coverage A/B/C of the surface of the graphite particles, where A and B are the peak areas for carbon and sodium, respectively, on the surface of the graphite particles as measured by energy-dispersive X-ray analysis and C is the degree of etherification of the carboxymethyl cellulose, is preferably 5.0×10⁻⁴ or more and 1.0×10⁻² or less. A relative coverage of less than 5.0×10⁻⁴ leads to insufficient adhesion of the coating layer. A relative coverage of more than 1.0×10⁻² which means that an excess of carboxymethyl cellulose is present on the surface of the active material, tends to result in reduced output power of the cell due to inhibited diffusion of the electrolytic solution.

The particle, diameters of the negative electrode active material, particles 13a and 13b are preferably in the ranges of 2 μm to 20 μm and 10 μm to 30 μm, respectively. In a setting where the particle diameter of the negative electrode active material particles 13b is greater than that of the negative electrode active material particles 13a, allowing a first coating layer with an average thickness of 10 nm to form on the surface of the negative electrode active material 13b will make it more likely that successful collection of current following the expansion or contraction of the negative electrode active material particles 13a will be ensured.

The negative electrode active material 13a is silicon-containing particles with a second coating layer on their surface. The second coating layer contains carboxymethyl cellulose.

The second coating layer has an average thickness of 10 nm or more, more preferably 12 nm or more. An average thickness of the second coating layer of less than 10 nm tends to result in failed collection of current following the expansion or contraction of the negative electrode active material particles 13a because of insufficient adhesion between the negative electrode active materials 13a and 13b. The average thickness of the second coating layer is: 300 nm or less, more preferably 200 nm or less. An average thickness of the second coating layer of more than 300 nm tends to result in low characteristics due to increased resistance of the coating layer leading to increased resistance of the cell.

The first or second coating layer preferably contains styrene-butadiene rubber. Adding styrene-butadiene rubber to the first or second coating layer improves the flexibility of the coating layer, thereby reducing the detachment and adhesion loss of the coating layer. The styrene-butadiene rubber is preferably dispersed inside the first coating layer or inside the second coating layer. The styrene-butadiene rubber may exist in the outermost portion of the first coating layer or that of the second coating layer.

The carboxymethyl cellulose in the negative electrode active material layer 12 preferably represents 1% by mass or more and 7% by mass or less of the negative electrode active material 13. An amount of less than 1% by mass leads to insufficient adhesion of the coating layers. An amount of more than 7% by mass, which means that, an excess of carboxymethyl cellulose is present within the negative electrode active material, tends to result in reduced output power of the cell due to inhibited diffusion of the electrolytic solution.

The styrene-butadiene rubber in the negative electrode active material layer 12 preferably represents 0.3% by mass or more and 2.0% by mass or less of the negative electrode active material 13. An amount of less than 0.3% by mass tends to result in the coating layer detaching during charge or discharge because of low flexibility of the coating layer. An amount of more than 2.0% by mass tends to result in low characteristics due to increased resistance of the coating layer.

An example of a method for allowing a coating layer of 10 nm or more on the surface of the negative electrode active materials 13a and 13b is to add water as a diluent to the negative electrode active materials 13a and 13b and carboxymethyl cellulose and knead the mixture with a solids content of 60% by mass or more.

The ratio by mass of the negative electrode active material particles 13a to the negative electrode active material particles 13b is in the range of 1:99 to 20:80, more preferably 3:95 to 10:90. When the proportion of the negative electrode active material particles 13a to the total mass of the negative electrode active materials is lover than 1% by mass, the negative electrode expands and contracts only to a small extent and thus does not sufficiently benefit from the effect of improved adhesion. When the proportion of the silicon-containing particles to the total mass of the negative electrode active materials is more than 20% by mass, the characteristics of the cell tend to be low because the negative electrode expands and contracts so greatly that the adhesion is insufficient.

### [Non-aqueous Electrolyte]

The electrolytic salt for the non-aqueous electrolyte can be, for example, LiClO₄, LiBF₄, LiPF₆, LiAlCl₄ LiSbF₆, LiSCN, LiCF₃SO₃, LiCF₃CO₂, LiAsF₆, LiB₁₀Cl₁₀, a lower aliphatic carboxylic acid lithium salt, LiCl, LiBr, Lii, chloroborane lithium, a boric acid salt, and an imide salt. In particular, LiPF₆ is preferred because of its ionic conductivity and electrochemical stability. Electrolytic salts can be used alone, and a combination of two or more electrolytic salts can also be used. These electrolytic salts are preferably contained in an amount of 0.8 to 1.5 mol per L of the non-aqueous electrolyte.

The solvent for the non-aqueous electrolyte can be, for example, a cyclic carbonate, a linear carbonate, or a cyclic carboxylate. Examples of cyclic carbonates include propylene carbonate (PC), ethylene carbonate (EC), and fluoroethylene carbonate (FEC). Examples of linear carbonates include diethyl carbonate (DEC), ethyl methyl carbonate (EMC), and dimethyl carbonate (DMC). Examples of cyclic carboxylates include γ-butyrolactone (GBL) and γ-valerolactone (GVL). An example of a linear carboxylate is methyl propionate (MP) fluoromethyl propionate (FMP). Non-aqueous solvents can be used alone, and a combination of two or more non-aqueous solvents can also be used.

### [Separator]

The separator is an ion-permeable and dielectric porous sheet. Specific examples of porous sheets include microporous thin film, woven fabric, and nonwoven fabric. The separator is preferably made of a polyolefin, such as polyethylene or polypropylene.

### EXAMPLES

The following describes the present invention in more detail by providing some examples. However, the present invention is not limited to these examples.

### Examples

### <Experiment 1>

### (Preparation of the Positive Electrode)

Lithium cobalt oxide, acetylene black (HS100, Denki Kagaku Kogyo K. K.), and polyvinylidene fluoride (PVdF) were weighed out according to ratios by mass of 95.0:2.5:2.5 and mixed. N-methyl-2-pyrrolidone (NMP) as a dispersion medium was added to the mixture. The resulting mixture was stirred using a mixer (T.K. HIVIS MIX, PRIMIX Corporation) to give positive electrode slurry. This positive electrode slurry was applied to both sides of a positive electrode collector that was an aluminum foil. After the applied coatings were dried, the collector was rolled using a roller to give a positive electrode composed of a positive electrode collector and a positive electrode mixture layer on both sides thereof. The packing density in the positive electrode mixture layer was 3.60 g/ml.

### (Preparation of the Negative Electrode)

The negative electrode active material was a mixture of carbon-coated SiOₓ (x=0.93; average primary particle diameter, 6.0 μm) and graphite (average primary particle diameter, 20 μm; BET specific surface area, 3.5 m²/g) in a ratio by mass of 10:90. Water as a diluent was added to this negative electrode active material and carboxymethyl cellulose sodium (CMC) to make the solids content (% by mass) 60%, and the resulting mixture was stirred for 30 minutes at a rotational speed of 40 rpm using a mixer (T.K. HIVIS MIX, PRIMIX Corporation) (primary kneading). After being stirred with water until the viscosity reached 1 Pa·s, the mixed solution was stirred with styrene-butadiene rubber (SBR) for 30 minutes to give negative electrode slurry. The ratios by mass negative electrode active material:CMC:SBR in the conditioning of this negative electrode slurry were

This negative electrode slurry was then uniformly applied to both sides of a negative electrode collector that was a copper foil, with the mass of the resulting negative electrode mixture layer per m² being 190 g. After the applied coatings were dried in air at 105° C., the collector was rolled using a roller to give a negative electrode composed of a negative electrode collector and a negative electrode mixture layer on both sides thereof. The packing density in the negative electrode mixture layer was 1.60 g/ml.

### [Preparation of the Non-aqueous Electrolytic Solution]

To a solvent mixture of ethylene carbonate (EC) and: diethyl carbonate (DEC) in a ratio by volume of 3:7, lithium hexafluorephpsphate (LiPF₆ ) was added to a concentration of 1.0 mole/liter.

### [Assembly of the Cell]

A tab was attached to each of the electrodes, and the positive and negative electrodes were wound into a spiral with the separator therebetween and the tabs positioned in the outermost portion to give a wound electrode body. This electrode body was inserted into a sheathing body made from an aluminum laminated sheet. After 2 hours of drying in a vacuum at 105° C., the non-aqueous electrolyte was injected, and the opening of the sheathing body was sealed to complete cell A1. The design capacity of battery A1 is 800 mAh.

### <Experiment 2>

Cell A2 was produced in the same way as cell A1 except that in the preparation of the negative electrode, the ratios by mass negative electrode active material:CMC:SBR in the conditioning of the negative electrode slurry were 96:3:1.

### <Experiment 3>

Cell A3 was produced in the same way as cell A1 except that in the preparation of the negative electrode, the ratios by mass negative electrode active material:CMC:SBR in

the conditioning of the: negative electrode slurry were 94:5:1.

### <Experiment 4>

Cell R1 was produced in the same way as cell A1 except that in the preparation of the negative electrode, the solids content in the primary kneading was 50%.

### <Experiment 5>

Cell A4 was produced in the same way as cell A1 except that in the preparation of the negative electrode, the negative electrode active material was a mixture of carbon-coated SiOₓ and graphite in a ratio by mass of 5:95.

### <Experiment 6>

Cell A5 was produced in the same way as cell A2 except that in the preparation of the negative electrode, the negative electrode active material was a mixture of carbon-coated SiOₓ and graphite in a ratio by mass of 5:95.

### <Experiment 7>

Cell A6 was produced in the same way as cell A3 except that in the preparation of the negative electrode, the negative electrode active material was a mixture of carbon-coated SiOₓ and graphite in a ratio by mass of 5:95.

### <Experiment 8>

Cell R2 was produced in the same way as cell R1 except that in the preparation of the negative electrode, the negative electrode active material was a mixture of carbon-coated SiOₓ and graphite in a ratio by mass of 5:95.

### (Measurement of the Thickness of the Coating Layer on the Graphite Surface)

For each of the negative electrodes, the thickness of the coating layer on the graphite surface was calculated as follows. A cross-section of the negative electrode was exposed using a cross-section polisher, and the obtained negative electrode cross-section was checked in SEM and SEM backscattered electron images under a scanning electron microscope (JSM-6500F, JEOL Ltd.). Under observational conditions of an accelerating voltage of 15 kV and a measurement magnification of 50,000, the interface between graphite and a CMC-containing layer was identified from the backscattered electron image. Five points of graphite particles were randomly selected, and the thickness measurements of the CMC-containing layer at five points on each graphite particle were averaged to give the thickness of the coating layer. The results are summarized in Table 1.

### (Measurement of Graphite Surface Coverage)

For each of the negative electrodes, the relative coverage of the coating layer on the graphite surface was measured. The negative electrode was bent, and a cross-section of the fractured negative electrode was subjected to energy-dispersive X-ray analysis (EDX) using a scanning electron microscope (JSM-6500F, JEOL Ltd.). The ratio of peak areas A/B, where A and B were the peak area for carbon (C) and that for sodium (Na), respectively, on the graphite surface, was measured. The ratio of peak intensities was normalized by the degree of etherification C (the abundance of sodium per cellulose backbone) of the carboxymethyl cellulose used in the experiment as in equation (1) below to give the relative coverage. The measurement was performed at two sites on each of five selected graphite particles with the area of measurement per site being 3 μm×3 μm, and the measurements of the five particles were averaged. The results are summarized in Table 1.

Relative coverage=A/B/C (1)

### (Measurement of Electrode Strength)

The electrode strength of each of the negative electrodes was measured as follows. The electrode cut on a 2-cm-long and 5-cm-wide strip was placed on the lateral surfaces of a 2.5-cm-wide glass plate using double adhesive tape to make an arch, and the top of the arch was pushed with a jig having a distal shape of 5 mm wide and 1 mm at a rate of 20 mm/min. The maximum reached load was defined as electrode strength. The results are summarized in Table 1.

### (Experiment)

Each of the cells was charged and discharged under the following conditions and examined for the percent retained capacity at cycle 50 defined in equation (2) below. The results are summarized in Table 1.

### [Conditions of Charge and Discharge Testing]

Charging

Constant-current charging was performed at a current of 1 It (800 mA) until the voltage reached 4.2 V. Constant-voltage charging was then performed at a constant voltage of 4.2 V until the current reached 1/20 It (40 mA).

Discharging

Constant-current discharge was performed at a current of 1 It (800 mA) until the voltage reached 2.75 V.

Halt

The duration of the halt between the above charging and discharge was 10 minutes.

[Equation Used to Calculate Percent Retained Capacity at Cycle 10]

Percent retained capacity at cycle 10(%):=(Discharge capacity at cycle 50/Discharge capacity at cycle 1)×100 (2)

TABLE 1

| | | | Solids | | | | |
|---|---|---|---|---|---|---|---|
| | | | content | | | | |
| | | CMC in | in | | | | |
| | SiOₓ to | negative | primary | Coating | | | Percent |
| | graphite | electrode | kneading | layer | Electrode | | retained |
| | (% by | (% by | (% by | thickness | strength | Relative | capacity |
| Cell | mass) | mass) | mass) | (nm) | (mN) | coverage | (%) |
| A1 | 10 | 1 | 60 | 10 | 72 | 6.0 × 10⁻⁴ | 87.6 |
| A2 | | 3 | 60 | 17 | 129 | 1.3 × 10⁻³ | 89.4 |
| A3 | | 5 | 60 | 20 | 186 | 2.2 × 10⁻³ | 91.5 |
| R1 | | 1 | 50 | 7 | 57 | 2.1 × 10⁻⁴ | 78.0 |
| A4 | 5 | 1 | 60 | 10 | 80 | 6.3 × 10⁻⁴ | 90.7 |
| A5 | | 3 | 60 | 17 | 130 | 1.5 × 10⁻³ | 92.9 |
| A6 | | 5 | 60 | 21 | 230 | 2.4 × 10⁻³ | 90.8 |
| R2 | | 1 | 50 | 7 | 57 | 2.0 × 10⁻⁴ | 85.0 |

As is clearly seen from Table 1, a 10-nm or thicker-coating layer on the graphite particles leads to improved percent retained capacity as compared with a 7-nm-thick coating layer. Furthermore, the improvement in the percent retained capacity of cells A1 to A3 as compared with cell R1 and the improvement in the percent retained capacity of cells A4 to A6 as compared with cell R2 are greater. The reason for this should be the following: The loss of percent

retained capacity due to the expansion and contraction of SiOₓ becomes more significant with increasing relative amount of SiOₓ to graphite, and forming a coating layer of 10 nm or more on graphite particles and thereby improving the adhesion within graphite and between graphite and SiOₓ ensured successful collection of current.

In this experiment, the thickness of the coating layer on graphite particles was measured; however, there should be a coating layer formed to a similar extent on the surface of SiOₓ particles, too.

### REFERENCE SIGNS LIST

10 Negative electrode

11 Negative electrode collector

12 Negative electrode active material layer

13, 13a, 13b Negative electrode active material

1. A negative electrode for a non-aqueous electrolyte secondary cell, the negative electrode comprising a negative electrode active material including silicon-containing particles and graphite particles and carboxymethyl cellulose, wherein:
the graphite particles have a first coating layer that contains carboxymethyl cellulose; and
the first coating layer has an average thickness of 10 nm or more.

2. The negative electrode according to claim 1 for a non-aqueous electrolyte secondary cell, wherein:
the silicon-containing particles have a second coating layer that contains carboxymethyl cellulose; and
the second coating layer has an average thickness of 10 nm or more.

3. The negative electrode according to claim 1 for a non-aqueous electrolyte secondary cell, wherein a relative coverage A/B/C, where A and B are peak areas for carbon and sodium, respectively, on a surface of the graphite particles as measured by energy-dispersive X-ray analysis and C is a degree of etherification of the carboxymethyl cellulose, is 5.0×10⁻⁴ or more.

4. The negative electrode according to claim 1 for a non-aqueous electrolyte secondary cell, wherein the first coating layer contains styrene-butadiene rubber.

5. The negative electrode according to claim 2 for a non-aqueous electrolyte secondary cell, wherein the second coating layer contains styrene-butadiene rubber.

6. The negative electrode according to claim 1 for a non-aqueous electrolyte secondary cell, wherein the carboxymethyl cellulose represents 1% by mass or more and 7% by mass or less of the negative electiode active material.

7. The negative electrode according to claim 1 for a non-aqueous electrolyte secondary cell, wherein a ratio by mass of the silicon-containing particles to the graphite particles is in a range of 1:99 to 20:80.
